(19) United States
(12) Patent Application Publication
(10) Pub. No.: US 2026/0359399 A1
(43) Pub. Date: Nov. 12, 2026

(54) System, Method, and Computer Program Product for Segmenting a Non-Fungible Token

(71) Applicant: Visa International Service Association, San Francisco, CA (US)

(72) Inventors: Surendra Vyas, Bangalore (IN); Som Madhab Bhattacharya, Bangalore (IN)

(21) Appl. No.: 19/109,209

(22) PCT Filed: Sep. 8, 2022
(86) PCT No.: PCT/US22/42825

§ 371 Date: Mar. 6, 2025

(51) Int. Cl. G06F 21/10

(52) U.S. Cl. CPC G06F 21/108; G06F 21/1014

(57) ABSTRACT

Provided are systems, methods, and computer program products for segmenting a master non-fungible token (NFT). The method includes minting an NFT on a blockchain network, segmenting the master NFT into a plurality of segments, each segment of the plurality of segments corresponding to at least one asset of a plurality of assets on the blockchain network, issuing assets of the plurality of assets to a plurality of users based on the plurality of users conducting eligible transactions, validating a request from a user of the plurality of users based on determining that the user has possession of a set of assets of the plurality of assets corresponding to the plurality of segments, and in response to validating the request, transferring the master NFT to the user via the blockchain network.

### CROSS REFERENCE TO RELATED APPLICATION

This application is the United States national phase of International Application No. PCT/US 22/42825, filed Sep. 8, 2022, the disclosure of which is hereby incorporated by reference in its entirety.

### BACKGROUND

### 1. Technical Field

The present disclosure relates generally to non-fungible tokens (NFTs) and, in some non-limiting aspects or embodiments, to systems, methods, and computer program products for segmenting an NFT.

### 2. Technical Considerations

Online engagement is a challenge faced by merchants and other entities that seek to interact with users through a network environment. Existing incentive and loyalty programs seek to encourage customer loyalty and participation, which can become increasingly difficult with a rising number of distractions when a user interacts with their device and/or an application (such as a mobile application or webpage). Moreover, users engage in incentive and loyalty programs on an individual level without any transparency over the operation and management of the same.

NFTs are assets that are maintained on and transferred within a blockchain network. Individuals may be interested in NFTs without having the know-how to engage with existing NFT tools and ecosystems.

### SUMMARY

According to non-limiting embodiments or aspects, provided is a computer-implemented method comprising: minting a master non-fungible token (NFT) on a blockchain network; segmenting the master NFT into a plurality of segments, each segment of the plurality of segments corresponding to at least one asset of a plurality of assets on the blockchain network; issuing assets of the plurality of assets to a plurality of users based on the plurality of users conducting eligible transactions; validating a request from a user of the plurality of users based on determining that the user has possession of a set of assets of the plurality of assets corresponding to the plurality of segments; and in response to validating the request, transferring the master NFT to the user via the blockchain network.

In non-limiting embodiments or aspects, the method further comprises: minting a plurality of individual NFTs on the blockchain network, each individual NFT representing a segment of the plurality of segments. In non-limiting embodiments or aspects, wherein issuing assets to the plurality of users comprises transferring ownership of individual NFTs to users via smart contracts on the blockchain network. In non-limiting embodiments or aspects, wherein issuing assets to the plurality of users comprises transferring the individual NFTs to the users via the blockchain network. In non-limiting embodiments or aspects, the master NFT comprises an image asset, and wherein each segment of the plurality of segments corresponds to a different portion of the image asset. In non-limiting embodiments or aspects, wherein segmenting the master NFT into the plurality of segments comprises segmenting an image corresponding to the master NFT into the plurality of segments, each segment representing a portion of the image, and wherein at least one segment of the plurality of segments corresponds to two or more assets of the plurality of assets.

According to non-limiting embodiments or aspects, provided is a system comprising: at least one processor programmed or configured to: mint a master non-fungible token (NFT) on a blockchain network; segment the master NFT into a plurality of segments, each segment of the plurality of segments corresponding to at least one asset of a plurality of assets on the blockchain network; issue assets of the plurality of assets to a plurality of users based on the plurality of users conducting eligible transactions; validate a request from a user of the plurality of users based on determining that the user has possession of a set of assets of the plurality of assets corresponding to the plurality of segments; and in response to validating the request, transfer the master NFT to the user via the blockchain network.

In non-limiting embodiments or aspects, the at least one processor is programmed or configured to: mint a plurality of individual NFTs on the blockchain network, each individual NFT representing a segment of the plurality of segments. In non-limiting embodiments or aspects, wherein issuing assets to the plurality of users comprises transferring ownership of individual NFTs to users via smart contracts on the blockchain network. In non-limiting embodiments or aspects, wherein issuing assets to the plurality of users comprises transferring the individual NFTs to the users via the blockchain network. In non-limiting embodiments or aspects, the master NFT comprises an image asset, and wherein each segment of the plurality of segments corresponds to a different portion of the image asset. In non-limiting embodiments or aspects, wherein segmenting the master NFT into the plurality of segments comprises segmenting an image corresponding to the master NFT into the plurality of segments, each segment representing a portion of the image, and wherein at least one segment of the plurality of segments corresponds to two or more assets of the plurality of assets.

According to non-limiting embodiments or aspects, provided is a computer program product comprising at least one non-transitory computer-readable medium including program instructions that, when executed by at least one processor, cause the at least one processor to: mint a master non-fungible token (NFT) on a blockchain network; segment the master NFT into a plurality of segments, each segment of the plurality of segments corresponding to at least one asset of a plurality of assets on the blockchain network; issue assets of the plurality of assets to a plurality of users based on the plurality of users conducting eligible transactions; validate a request from a user of the plurality of users based on determining that the user has possession of a set of assets of the plurality of assets corresponding to the plurality of segments; and in response to validating the request, transfer the master NFT to the user via the blockchain network.

In non-limiting embodiments or aspects, the program instructions further cause the at least one processor to: mint a plurality of individual NFTs on the blockchain network, each individual NFT representing a segment of the plurality of segments. In non-limiting embodiments or aspects, wherein issuing assets to the plurality of users comprises transferring ownership of individual NFTs to users via smart contracts on the blockchain network. In non-limiting embodiments or aspects, wherein issuing assets to the plurality of users comprises transferring the individual NFTs to the users via the blockchain network. In non-limiting embodiments or aspects, the master NFT comprises an image asset, and wherein each segment of the plurality of segments corresponds to a different portion of the image asset. In non-limiting embodiments or aspects, wherein segmenting the master NFT into the plurality of segments comprises segmenting an image corresponding to the master NFT into the plurality of segments, each segment representing a portion of the image, and wherein at least one segment of the plurality of segments corresponds to two or more assets of the plurality of assets.

Further non-limiting embodiments or aspects are set forth in the following numbered clauses:
Clause 1: A computer-implemented method comprising: minting a master non-fungible token (NFT) on a blockchain network; segmenting the master NFT into a plurality of segments, each segment of the plurality of segments corresponding to at least one asset of a plurality of assets on the blockchain network; issuing assets of the plurality of assets to a plurality of users based on the plurality of users conducting eligible transactions; validating a request from a user of the plurality of users based on determining that the user has possession of a set of assets of the plurality of assets corresponding to the plurality of segments; and in response to validating the request, transferring the master NFT to the user via the blockchain network.
Clause 2: The computer-implemented method of clause 1, further comprising: minting a plurality of individual NFTs on the blockchain network, each individual NFT representing a segment of the plurality of segments.
Clause 3: The computer-implemented method of clauses 1 or 2, wherein issuing assets to the plurality of users comprises transferring ownership of individual NFTs to users via smart contracts on the blockchain network.
Clause 4: The computer-implemented method of any of clauses 1-3, wherein issuing assets to the plurality of users comprises transferring the individual NFTs to the users via the blockchain network.
Clause 5: The computer-implemented method of any of clauses 1-4, wherein the master NFT comprises an image asset, and wherein each segment of the plurality of segments corresponds to a different portion of the image asset.
Clause 6: The computer-implemented method of any of clauses 1-5, wherein segmenting the master NFT into the plurality of segments comprises segmenting an image corresponding to the master NFT into the plurality of segments, each segment representing a portion of the image, and wherein at least one segment of the plurality of segments corresponds to two or more assets of the plurality of assets.
Clause 7: A system comprising: at least one processor programmed or configured to: mint a master non-fungible token (NFT) on a blockchain network; segment the master NFT into a plurality of segments, each segment of the plurality of segments corresponding to at least one asset of a plurality of assets on the blockchain network; issue assets of the plurality of assets to a plurality of users based on the plurality of users conducting eligible transactions; validate a request from a user of the plurality of users based on determining that the user has possession of a set of assets of the plurality of assets corresponding to the plurality of segments; and in response to validating the request, transfer the master NFT to the user via the blockchain network.
Clause 8: The system of clause 7, wherein the at least one processor is programmed or configured to: mint a plurality of individual NFTs on the blockchain network, each individual NFT representing a segment of the plurality of segments.
Clause 9: The system of clauses 7 or 8, wherein issuing assets to the plurality of users comprises transferring ownership of individual NFTs to users via smart contracts on the blockchain network.
Clause 10: The system of any of clauses 7-9, wherein issuing assets to the plurality of users comprises transferring the individual NFTs to the users via the blockchain network.
Clause 11: The system of any of clauses 7-10, wherein the master NFT comprises an image asset, and wherein each segment of the plurality of segments corresponds to a different portion of the image asset.
Clause 12: The system of any of clauses 7-11, wherein segmenting the master NFT into the plurality of segments comprises segmenting an image corresponding to the master NFT into the plurality of segments, each segment representing a portion of the image, and wherein at least one segment of the plurality of segments corresponds to two or more assets of the plurality of assets.
Clause 13: A computer program product comprising at least one non-transitory computer-readable medium including program instructions that, when executed by at least one processor, cause the at least one processor to: mint a master non-fungible token (NFT) on a blockchain network; segment the master NFT into a plurality of segments, each segment of the plurality of segments corresponding to at least one asset of a plurality of assets on the blockchain network; issue assets of the plurality of assets to a plurality of users based on the plurality of users conducting eligible transactions; validate a request from a user of the plurality of users based on determining that the user has possession of a set of assets of the plurality of assets corresponding to the plurality of segments; and in response to validating the request, transfer the master NFT to the user via the blockchain network.
Clause 14: The computer program product of clause 13, wherein the program instructions further cause the at least one processor to: mint a plurality of individual NFTs on the blockchain network, each individual NFT representing a segment of the plurality of segments.
Clause 15: The computer program product of clauses 13 or 14, wherein issuing assets to the plurality of users comprises transferring ownership of individual NFTs to users via smart contracts on the blockchain network.
Clause 16: The computer program product of any of clauses 13-15, wherein issuing assets to the plurality of users comprises transferring the individual NFTs to the users via the blockchain network.
Clause 17: The computer program product of any of clauses 13-16, wherein the master NFT comprises an image asset, and wherein each segment of the plurality of segments corresponds to a different portion of the image asset.
Clause 18: The computer program product of any of clauses 13-17, wherein segmenting the master NFT into the plurality of segments comprises segmenting an image corresponding to the master NFT into the plurality of segments, each segment representing a portion of the image, and wherein at least one segment of the plurality of segments corresponds to two or more assets of the plurality of assets.

These and other features and characteristics of the presently disclosed subject matter, as well as the methods of operation and functions of the related elements of structures and the combination of parts and economies of manufacture, will become more apparent based on the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure. As used in the specification and the claims, the singular form of “a,” “an,” and “the” include plural referents unless the context clearly dictates otherwise.

### BRIEF DESCRIPTION OF THE DRAWINGS

Additional advantages and details of the disclosed subject matter are explained in greater detail below with reference to the exemplary embodiments or aspects that are illustrated in the accompanying figures, in which:

FIG. 1 is a schematic diagram of a system for segmenting NFTs according to non-limiting aspects or embodiments;

FIG. 2 illustrates a segmented master NFT according to non-limiting aspects or embodiments;

FIG. 3 is a flowchart of a method for segmenting NFTs according to non-limiting aspects or embodiments;

FIGS. 4A-4C are graphical user interfaces used in connection with a system for segmenting NFTs according to non-limiting aspects or embodiments;

FIGS. 5A-5C are further graphical user interfaces used in connection with a system for segmenting NFTs according to non-limiting aspects or embodiments;

FIG. 6 is a further schematic diagram of a system for segmenting NFTs according to non-limiting aspects or embodiments; and

FIG. 7 is a diagram of components of one or more devices of FIG. 1 according to non-limiting aspects or embodiments.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings and described in the following specification, are simply exemplary embodiments or aspects of the disclosure. Hence, specific dimensions and other physical characteristics related to the embodiments or aspects of the embodiments disclosed herein are not to be considered as limiting unless otherwise indicated.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. In addition, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the terms “communication” and “communicate” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some non-limiting embodiments, a message may refer to a network packet (e.g., a data packet and/or the like) that includes data.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the terms “issuer,” “issuer institution,” “issuer bank,” or “payment device issuer” may refer to one or more entities that provide accounts to individuals (e.g., users, customers, and/or the like) for conducting payment transactions, such as credit payment transactions and/or debit payment transactions. For example, an issuer institution may provide an account identifier, such as a primary account number (PAN), to a customer that uniquely identifies one or more accounts associated with that customer. In some non-limiting embodiments, an issuer may be associated with a bank identification number (BIN) that uniquely identifies the issuer institution. As used herein, “issuer system” may refer to one or more computer systems operated by or on behalf of an issuer, such as a server executing one or more software applications. For example, an issuer system may include one or more authorization servers for authorizing a transaction.

As used herein, the term “merchant” may refer to one or more entities (e.g., operators of retail businesses) that provide goods and/or services, and/or access to goods and/or services, to a user (e.g., a customer, a consumer, and/or the like) based on a transaction, such as a payment transaction. As used herein, “merchant system” may refer to one or more computer systems operated by or on behalf of a merchant, such as a server executing one or more software applications. As used herein, the term “product” may refer to one or more goods and/or services offered by a merchant.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices and/or components of such (e.g., processors, servers, client devices, software applications, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa®, MasterCard®, American Express®, or any other entity that processes transactions. As used herein, “transaction processing system” may refer to one or more computer systems operated by or on behalf of a transaction service provider, such as a transaction processing server executing one or more software applications. A transaction processing system may include one or more processors and, in some non-limiting embodiments, may be operated by or on behalf of a transaction service provider.

Provided are systems, methods, and computer program products for segmenting NFTs that enable dynamic offers to be integrated with transactions in a blockchain network. Non-limiting embodiments described herein provide for an improved merchant and/or issuer loyalty system in which digital assets are used to prevent fraud, provide transparency, and encourage participation through gamification. Non-limiting embodiments provide for a dynamic rewards structure that varies over time based on user engagement.

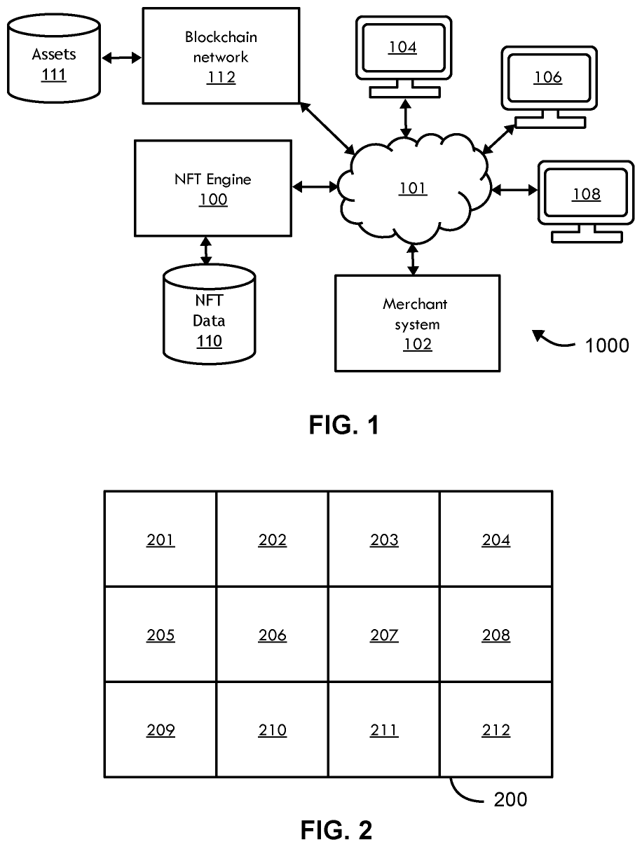

Referring to FIG. 1, illustrated is a diagram of a system 1000 for segmenting NFTs according to a non-limiting embodiment. As illustrated in FIG. 1, the system 1000 includes an NFT engine 100 in communication with NFT data 110. The NFT engine 100 may include software executing on one or more computing devices. The NFT data 110 may be stored on a data storage device in communication with the NFT engine 100. The system 1000 also includes a merchant system 102 and user computing devices 104, 106, 108. It will be appreciated that any number of merchant systems and/or user computing devices may be included in the system 1000. The NFT engine 100, merchant system 102, and user computing devices 104, 106, 108 may communicate via a public or private network 101, such as the Internet. In non-limiting embodiments, the network 101 may be a payment network including and/or in communication with one or more issuer systems, acquirer systems, transaction processing systems, payment gateways, and/or other systems involved in processing a payment transaction. The NFT engine 100, merchant system 102, and user computing devices 104, 106, 108 may be in communication with a blockchain network 112. In some non-limiting embodiments, one or more of the NFT engine 100, merchant system 102, and user computing devices 104, 106, 108 may operate as nodes in the blockchain network 112 such that they host a distributed ledger associated with the blockchain network 112 and/or perform other actions in connection with the blockchain network 112.

The blockchain network 112 may include any public or private blockchain. For example, non-limiting embodiments may be implemented on the Ethereum blockchain, the Solana blockchain, a public or private blockchain specially purposed for the system 1000, and/or any other blockchain.

With continued reference to FIG. 1, in non-limiting embodiments the NFT engine 100 may be part of and/or operated by an issuer system, payment gateway, and/or transaction processing system (not shown in FIG. 1). In other non-limiting embodiments, the NFT engine 100 may be part of and/or operated by the merchant system 102. It will be appreciated that the functionality of the NFT engine 100 described herein may also be performed by multiple different computing devices and/or software functions. For example, in some non-limiting embodiments a transaction processing system and/or issuer system may operate the NFT engine 100 such that it is usable by merchants (e.g., merchant system 102) to customize NFT campaigns by uploading digital media (e.g., images) to use for the master NFTs and parameters, such as a number of segments, weights, values, rewards, rules, and/or the like. In some non-limiting embodiments, a transaction processing system and/or issuer system may operate the NFT engine 100 such that it is usable by the issuer to customize NFT campaigns to reward account holders for making purchases using one or more accounts. In some non-limiting embodiments, an additional entity, such as a third-party service provider, may operate the NFT engine 100 as a service provided to merchant systems 102 and/or issuer systems.

In non-limiting embodiments, the NFT data 110 may include digital media files, such as images, videos, and/or audio, associated with one or more merchants. In non-limiting embodiments, the NFT engine 100 mints each digital media file on the blockchain network 112 as one or more master NFTs. As used herein, the term “master NFT” refers to a complete digital media file, such as an image, video, and/or audio file, that has been tokenized and distributed on a blockchain network 112. Each master NFT may be minted on the blockchain and associated with a blockchain address (e.g., digital wallet address) corresponding to the NFT engine 100 and/or merchant system 102 associated with the master NFT. It will be appreciated that various other entities may maintain custody of the master NFT(s), such as but not limited to issuer systems, payment gateways, transaction processing systems, third-party service providers, and/or the like.

In non-limiting embodiments, the NFT engine 100 segments (e.g., partitions) each master NFT into a plurality of segments. One or more copies of each segment are stored as assets within the NFT data 110 such that the assets can be individually distributed to users operating user computing devices 104, 106, 108. As used herein, the term “asset” refers to a digital media file, such as an image, video, and/or audio file, that represents a segment of a master NFT. Each segment of a master NFT may correspond to one or more assets. For example, a master NFT in the form of an image may be partitioned into individual segment image pieces that, when grouped together, form the full image. The segments and corresponding assets may be static or variable in size (e.g., number of pixels). The NFT engine 100 and/or another system or entity may assign properties to each asset such that the asset properties for a given asset identify a weight and/or value of the asset. In non-limiting embodiments, each asset may have a different weight and/or value.

In non-limiting embodiments, each asset may be minted on the blockchain as individual NFTs (e.g., piece NFTs) and associated with a blockchain address (e.g., digital wallet address) corresponding to the NFT engine 100 and/or merchant system 102 associated with the corresponding master NFT. It will be appreciated that various other entities may maintain custody of the asset NFTs, such as but not limited to issuer systems, payment gateways, transaction processing systems, third-party service providers, and/or the like. In non-limiting embodiments, the assets may be transferred to users (e.g., such as users associated with computing devices 104, 106, 108) in response to a user meeting a qualification. For example, one or more assets may be transferred to a user in response to the user making an eligible transaction. As used herein, the term “eligible transaction” may refer to a transaction having one or more predetermined properties. For example, an eligible transaction may be a transaction satisfying a threshold value, a transaction for a certain item or service, a transaction that increases a transaction frequency to satisfy a threshold value, and/or the like. An eligible transaction may involve a user and a merchant (e.g., a merchant associated with the merchant system 102). In non-limiting embodiments, a user may be transferred to an asset selected at random from a pool of assets in response to an eligible transaction. In some non-limiting embodiments, a user may be transferred to a specific asset based on a user profile, transaction data (e.g., a particular type of eligible transaction), and/or the like in response to an eligible transaction.

In some non-limiting embodiments, the NFTs may be transferred directly to the users (e.g., to blockchain addresses for each user). In some non-limiting embodiments, the asset NFTs may be transferred to the users via smart contracts such that the user does not have custody of the NFTs but can establish possession via the smart contract. For example, the NFT engine 100, merchant system 102, and/or other system or entity may maintain custody of the assets (e.g., the asset NFTs may be stored at a blockchain address associated with the NFT engine 100 or other system) and may issue smart contracts on the blockchain network 112 to lease the assets to the users. In non-limiting embodiments, a smart contract may be executed with a user's blockchain address to establish the user's possession of the asset under the terms of the contract. In some non-limiting embodiments, the smart contracts may specify a time period and/or expiration date for the asset or an associated offer such that the lease is only valid for a limited amount of time. For example, the time period may be based on a particular challenge. In some non-limiting embodiments, after a time period expires the asset(s) may be automatically returned to a pool of assets available for distribution to other users.

In non-limiting embodiments, a user may collect assets and hold the assets or smart contracts that lease the assets to the user in a digital wallet. A collection of assets representing all or a portion of a corresponding master NFT may be used by a user in various ways. For example, in non-limiting embodiments a user may collect all of the assets that, together, form the master NFT, and be rewarded with the master NFT for the collection. In some non-limiting embodiments, a subset of assets that form a portion of the master NFT may also be collected and used to obtain a reward (e.g., such as a discount, free item, the master NFT, and/or the like).

In non-limiting embodiments, a user may communicate a request (e.g., a redemption request) for the master NFT to the NFT engine 100. The request may be generated by, for example, a user computing device 108, a digital wallet application, and/or any computing device in communication with the NFT engine 100. In response to receiving the request, the NFT engine 100 may validate the request by determining that the user has possession of the assets. For example, the request may be validated using a public key associated with the user to validate a digital signature or other cryptographic operation conducted with the user's private key to establish that the user has custody of the assets or has possession of the assets via smart contracts. It will be appreciated that various ways to validate the user's possession of the assets may be used by the NFT engine 100. The NFT engine 100, in response to validating the request, may transfer the master NFT to the user via the blockchain network 112.

In non-limiting embodiments, the NFT engine 100 may issue (e.g., mint and transfer) any number of assets relating to the master NFT. For example, the assets may include numerous duplicate versions of the same asset where some assets (e.g., particular portions of an image or other media file) may be more common than others such that a first number of first assets may be minted and a second number of second assets may be minted, where the second number is less than the first number. In this manner, the second assets may be rarer than the first assets. Weights or values of each asset may determine the scarcity of the assets and may dynamically change over time based on user engagement, demand, and/or the like.

Referring now to FIG. 2, a master NFT 200 is shown according to non-limiting embodiments. The master NFT 200 is segmented into individual segments 201-212. In non-limiting embodiments, different numbers of each individual segment 201-212 may be generated as assets. For example, there may be two (2) assets of each of segments 201-204, four (4) assets of each of segments 205-208, and eight (8) assets of segments 209-212. In non-limiting embodiments, each segment 201-212 may be associated with a weight or value. In some examples, a weight of each segment may determine the number of assets that are generated for that segment such that more assets are generated for segments with lower weights than for segments with relatively larger weights.

Although the master NFT 200 shown in FIG. 2 is rectangular and includes twelve (12) segments 201-212, it will be appreciated that the master NFT may be any shape in non-limiting embodiments in which the master NFT is visual, such as an image or video. The segments 201-212 may also be any shape or size and may be equal in size or variable in size. In examples in which the master NFT is a video, the video may be partitioned into segments by length (e.g., clips of the full video) and/or may be partitioned into segments by visual portion (e.g., such as shown in the master NFT 200 in FIG. 2). The media files used for master NFTs may be segmented in any manner.

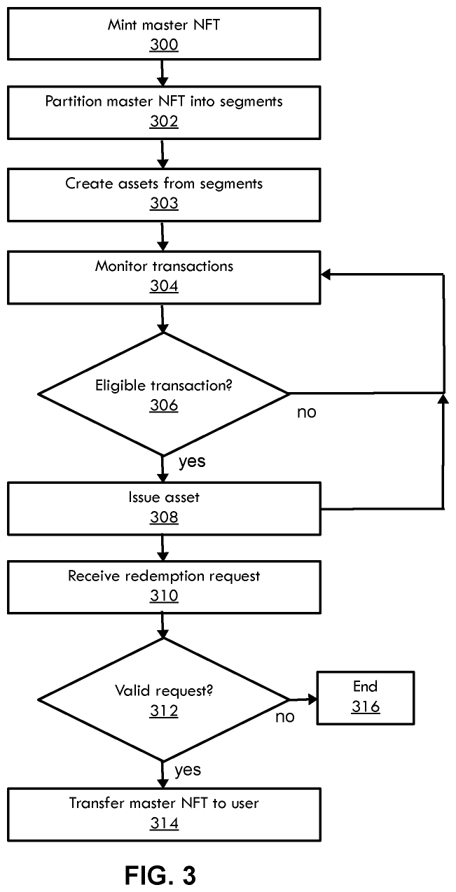

Referring now to FIG. 3, a flow diagram is shown for a method for segmenting an NFT according to non-limiting embodiments. The steps in FIG. 3 are for exemplary purposes only and it will be appreciated that additional, fewer, and/or a different order of steps may be used in non-limiting embodiments. At step 300, one or more master NFTs may be minted onto the blockchain associated with a blockchain network. A master NFT may include any form of media file, such as an image, video, or audio file, and in some examples may be related to a merchant. For example, a coffee shop may use an image of a cup of coffee, an automotive store may use an image of a car, a merchant may use a logo, and/or the like.

With continued reference to FIG. 3, at step 302 the media file corresponding to the master NFT may be segmented into a plurality of segments. The segments may be any shape or size and may be equal or variable in shape and size. For example, the master NFT may be segmented into a matrix of equal-sized segments as shown in FIG. 2. At step 303, a plurality of assets is created from the plurality of segments. For example, at least one asset may be generated from each segment of the plurality of segments by creating one or more copies of the segment. In non-limiting embodiments, a plurality of assets is generated for each segment of the plurality of segments. The number of assets generated for each segment may be the same or different. As an example, in some non-limiting embodiments a plurality of individual NFTs may be generated for each segment and minted to the blockchain, such that each individual NFT is an asset.

At step 304 of FIG. 3, transactions are monitored in a payment network. In non-limiting embodiments, transactions may be monitored by a transaction processing system, an issuer system, a payment gateway, and/or a merchant system, as examples. In non-limiting embodiments, each payment transaction may be monitored by processing transaction parameters, such as but not limited to transaction value, transaction time, transaction frequency, and/or a specific item or service being transacted for, based on one or more rules. At step 306, it is determined whether the transaction is an eligible transaction. For example, an eligible transaction may be a transaction having a value that satisfies (e.g., meets or exceeds) a threshold value, a transaction that increased a transaction count or frequency to satisfy a threshold value (e.g., the third transaction in a month or the like), a transaction for a particular item or service, a transaction occurring at a particular date and/or time, and/or the like. Rules may be applied to the transaction data for each transaction to determine if it is an eligible transaction. The rules may be provided by a merchant, issuer, and/or the like. The method may loop back to step 304 for continued monitoring if there are no eligible transactions.

Still referring to FIG. 3, if an eligible transaction is determined at step 306, the method may proceed to step 308 in which one or more assets are issued to a user. The asset(s) may be issued to the user by transferring individual NFTs representing the assets to a blockchain address of the user by leasing the assets to the users (e.g., executing a smart contract with a user's blockchain address to establish possession under the terms of the contract) and/or the like. In non-limiting embodiments, the asset(s) issued to the user may be selected randomly by an algorithm from the total number of available assets or a subset of available assets. In non-limiting embodiments, the asset(s) issued to the user may be selected based on the eligible transaction. For example, different assets may correspond with different types of eligible transactions based on rules. For example, a transaction having a transaction value satisfying a threshold may be associated with a first asset or subset of assets, a transaction having a transaction value satisfying a second threshold different than the first threshold may be associated with a second asset or subset of assets, a transaction for a first item may be associated with a third asset or subset of assets, a transaction for a second item may be associated with a fourth asset or subset of assets, and/or the like.

At step 310 of FIG. 3, a request (e.g., redemption request) is received by the NFT engine, merchant system, issuer system, transaction processing system, and/or any other system configured to receive a request message. The request may be initiated by a user in possession of one or more assets. In some non-limiting embodiments the request may be initiated through an Application Programming Interface (API) connecting a user application to an NFT engine. For example, a user may cause the request to be generated through a digital wallet application. In some non-limiting embodiments, the request may be generated based on an algorithm that proves that the user has possession of the asset(s). Such an algorithm may, for example, use a digital signature generated based on a user's private key corresponding to the user's blockchain address that holds the asset(s) or is party to corresponding smart contracts. In some non-limiting embodiments, the request may identify the asset(s) and/or a reward that the user seeks to obtain (e.g., the master NFT, one or more other asset NFTs, a discount, and/or the like). In some non-limiting embodiments, the request may involve multiple steps including an initial request and a response including a challenge (e.g., a cryptographic challenge, a password challenge, and/or the like) from the NFT engine, issuer system, merchant system, transaction processing system, and/or the like.

At step 312 of FIG. 3, it is determined whether the request received at step 312 is valid. For example, in non-limiting embodiments the NFT engine, issuer system, merchant system, and/or transaction processing system may validate a digital signature of the request or accompanying the request based on the user's public key to determine whether the request is valid. In some non-limiting embodiments, determining whether the request received at step 312 is valid may include validating a password, user identity, and/or the like. If the request is not valid the method may end at step 316 and, in some non-limiting embodiments, a notification may be generated and communicated to the user. If the request is valid, the method may proceed to step 314 in which the master NFT or other reward is transferred to the user. For example, the master NFT may be transferred from an existing blockchain address to a blockchain address associated with the user. The user may maintain the master NFT on the user's device (e.g., through a digital wallet) or, in other examples, the master NFT may be under the custody of an exchange that establishes the user's possession with credentials (e.g., password, key, and/or the like).

In non-limiting embodiments, a user may redeem one or more asset(s) for a reward other than or in addition to the master NFT. For example, one or more assets may be redeemed for an offer, such as a coupon for a discount. In non-limiting embodiments, one or more smart contracts associated with the assets may define rules for redeeming the assets.

In non-limiting embodiments, a master NFT and/or one or more asset NFTs may be associated with one or more smart contracts that provide a utility to the user that possesses it. For example, a user may utilize a master NFT to access offers such as discounts, exclusive products or services, and/or the like. In non-limiting embodiments, a user may establish possession of the master NFT through a cryptographic challenge. For example, a user may generate a digital signature using a private key associated with a blockchain address of the master NFT such that the digital signature can be verified with a public key by a merchant system, issuer system, transaction processing system, and/or the like.

In non-limiting embodiments, users may exchange NFTs with other users throughout the blockchain network. For example, users may exchange individual asset NFTs and/or master NFTs through one or more exchange platforms that facilitate transactions on the blockchain network. In this manner, users may trade duplicate assets for assets that they need to complete a master NFT and/or a set of assets for a reward. Assets may be exchanged among users by transferring the asset NFTs from one blockchain address to another blockchain address or by a smart contract (e.g., transferring existing smart contracts that lease the asset NFT or entering into a new smart contract). Any platform used for exchanging NFTs may be used to exchange asset NFTs.

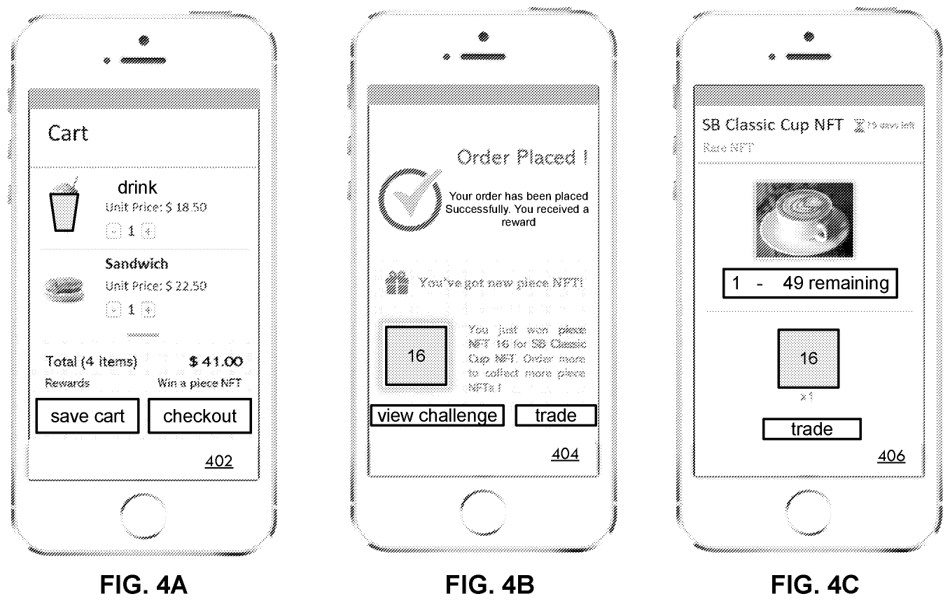

Referring now to FIGS. 4A-4C, shown are graphical user interfaces (GUIs) used to obtain one or more assets according to non-limiting embodiments. The GUIs 402, 404, 406 may be displayed by a merchant application (e.g., a mobile application or webpage), an issuer application (e.g., a mobile application or webpage), an electronic wallet application, or any other application accessible to a user. On a first GUI 402 shown in FIG. 4A, a user may be presented with a reward (e.g., an asset NFT) upon checking out with an eligible transaction. Once a user checks out (e.g., initiates a transaction) on the first GUI 402, a second GUI 404 may be displayed that notifies the user of the asset. For example, the second GUI 404 shown in FIG. 4B identifies the asset by a number (asset 16) or other identifier. The second GUI 404 also has selectable options for a user to view a challenge (e.g., a number of assets needed for a reward) and to trade the asset they were rewarded. A challenge and progress is shown in a third GUI 406 shown in FIG. 4C, where a user is shown what asset(s) they currently possess (e.g., a single asset 16 in the depicted example) and the assets they still need to collect (e.g., 49 remaining assets). The GUI 406 may also display a time limit (e.g., a number of days left to amass all of the assets needed for the challenge).

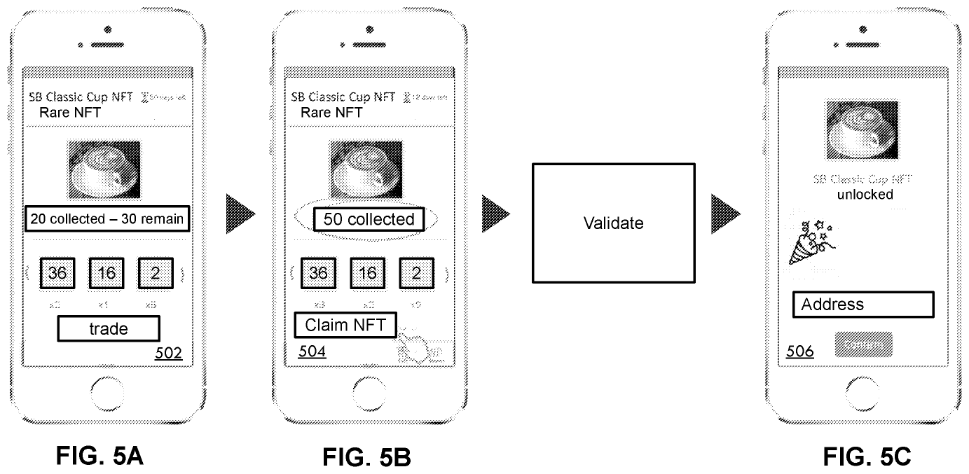

Referring now to FIGS. 5A-5C, shown are GUIs used to collect and redeem one or more assets according to non-limiting embodiments. The GUIs 502, 504, 506 may be displayed by a merchant application (e.g., a mobile application or webpage), an issuer application (e.g., a mobile application or webpage), an electronic wallet application, or any other application accessible to a user. On a first GUI 502 shown in FIG. 5A, a challenge and progress is shown. In this example, the user has collected 20 assets and 30 assets are remaining to complete the challenge of all 50 assets. The user may be able to view the assets. In the example shown in FIG. 5A, a user may scroll through the assets that have been collected (e.g., asset 36, asset 16, asset 2). The GUI 502 may show how many of each asset the user has (e.g., x2 for asset 36, x1 for asset 16, x5 for asset 2) and provide a selectable option for the user to trade one or more assets (e.g., through one or more exchange platforms or directly between users).

Referring to FIG. 5B, the GUI 504 shows that a challenge has been completed (e.g., 50 assets have been collected). A selectable option may be provided for the user to claim the reward (e.g., claim the master NFT), in response to which a redemption request may be generated by the application that is communicated to and validated by the NFT engine, issuer system, merchant system, and/or transaction processing system. Referring to FIG. 5C, a validation GUI 506 is shown to notify the user that the redemption request for the reward (e.g., the master NFT) is valid. A user may be prompted through the GUI 506 to provide information for receiving the reward. For example, a user may be prompted for a blockchain address that can be input by typing the address or scanning a QR code held by the user.

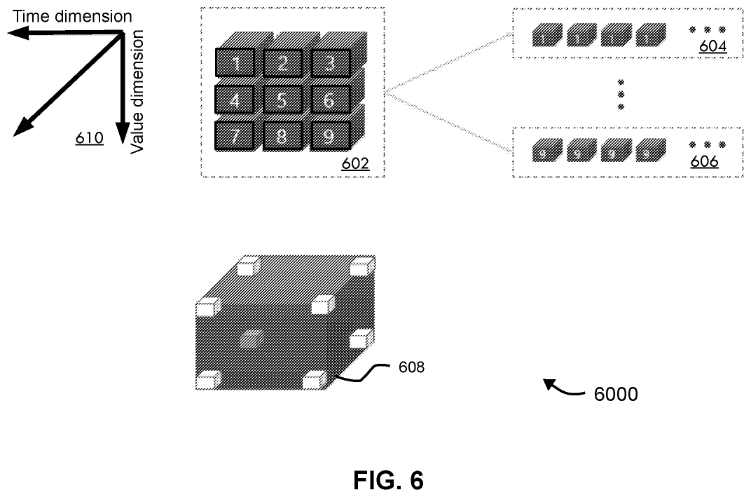

Referring now to FIG. 6, illustrated is a diagram of a system 6000 for segmenting NFTs according to non-limiting embodiments. The example shown in FIG. 6 illustrates a non-limiting embodiment including individual NFTs 604, 606, and master NFTs 608. In such an example, the individual NFTs 604, 606 are collected by users such that there may be multiple instances of each individual NFT 604, 606 that correspond to one segment of the master NFT 608. In FIG. 6, a cross-sectional view 602 of the master NFT 608 is shown illustrating nine (9) segments that each correspond to individual NFTs 604, 606. The cross-sectional view 602 represents all of the piece NFTs needed to form a master NFT. Each individual NFT 604, 606 may have multiple instances (e.g., multiple, separate copies minted, not shown in the cross-sectional view 602) depending on associated parameters. The individual NFTs 604, 606 may be assets that are rewarded to users as described herein. A user may collect a number of different individual NFTs 604, 606 that correspond to one or more segments of the master NFT. In some examples, a user may collect matching (e.g., duplicative) individual NFTs 604, 606. For example, ownership of at least one of each individual NFT 604, 606 comprising the master NFT 608 may be required to obtain the master NFT 608. In this manner, a user may collect all of the individual NFTs that comprise the master NFT 608 to earn the master NFT 608.

With continued reference to FIG. 6, the master NFT 608 may be represented as a three-dimensional matrix (e.g., cube) in which each NFT comprises a coordinate (e.g., pointer) to a particular location in the matrix. Each NFT may also comprise a volume of the master NFT (e.g., where an individual NFT 604, 606 has a smaller volume, and the master NFT 608 has a maximum volume). In non-limiting embodiments, once a collection of individual NFTs (e.g., piece NFTs) is used to redeem a master NFT 608, the constituent NFTs (e.g., the individual NFTs 604, 606 used to redeem) may continue to exist on the blockchain network but the value may be reduced since the larger NFT denotes a larger volume. Through the blockchain, any participant may view the current matrix completion status, verify ownership of any of the NFTs, and/or the like.

With continued reference to FIG. 6, a chart 610 shows a relationship between time and NFT value according to non-limiting embodiments in which multiple users compete for a single master NFT. As users transact more frequently, they may progress further on the time dimension. Larger transactions also progress the consumers further on the value dimension. As a result, users may be encouraged to conduct larger transactions more frequently to improve their chances at obtaining the master NFT. In non-limiting embodiments, different and/or additional dimensions may be used to determine the relative value (e.g., and corresponding weight and/or rarity) of each individual NFT. Different parameters may be chosen for a program. For example, a merchant may specify one or more parameters to be used as dimensions for calculating a value of the different individual NFTs.

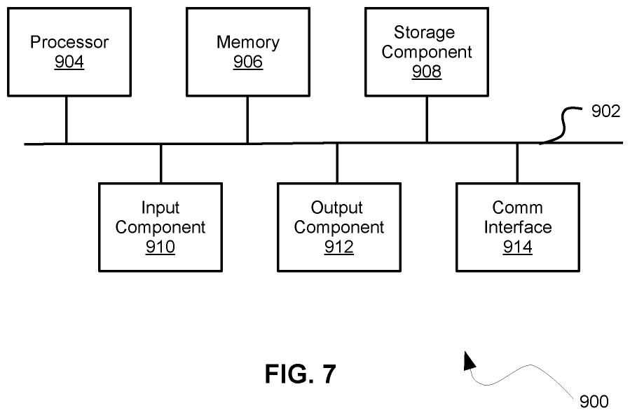

Referring now to FIG. 7, shown is a diagram of example components of a computing device 900 for implementing and performing the systems and methods described herein according to non-limiting embodiments. In some non-limiting embodiments, device 900 may include additional components, fewer components, different components, or differently arranged components than those shown in FIG. 7. Device 900 may include a bus 902, a processor 904, memory 906, a storage component 908, an input component 910, an output component 912, and a communication interface 914. Bus 902 may include a component that permits communication among the components of device 900. In some non-limiting embodiments, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), virtual or augmented reality depicting systems and devices, etc.) that can be programmed to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 7, storage component 908 may store information and/or software related to the operation and use of device 900. For example, storage component 908 may include a hard disk (e.g., a magnetic disk, an optical disk, a magneto-optic disk, a solid-state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a global positioning system (GPS) component, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer-readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices. The terms “programmed to,” “configured to,” and/or “programmed or configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

Although examples have been described in detail for the purpose of illustration based on what is currently considered to be the most practical and preferred aspects or embodiments, it is to be understood that such detail is solely for that purpose and that the principles described by the present disclosure are not limited to the disclosed aspects or embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A computer-implemented method comprising:
minting a master non-fungible token (NFT) on a blockchain network;
segmenting the master NFT into a plurality of segments, each segment of the plurality of segments corresponding to at least one asset of a plurality of assets on the blockchain network;
issuing assets of the plurality of assets to a plurality of users based on the plurality of users conducting eligible transactions;
validating a request from a user of the plurality of users based on determining that the user has possession of a set of assets of the plurality of assets corresponding to the plurality of segments; and
in response to validating the request, transferring the master NFT to the user via the blockchain network.

2. The computer-implemented method of claim 1, further comprising:
minting a plurality of individual NFTs on the blockchain network, each individual NFT representing a segment of the plurality of segments.

3. The computer-implemented method of claim 2, wherein issuing assets to the plurality of users comprises transferring ownership of individual NFTs to users via smart contracts on the blockchain network.

4. The computer-implemented method of claim 2, wherein issuing assets to the plurality of users comprises transferring the individual NFTs to the users via the blockchain network.

5. The computer-implemented method of claim 1, wherein the master NFT comprises an image asset, and wherein each segment of the plurality of segments corresponds to a different portion of the image asset.

6. The computer-implemented method of claim 1, wherein segmenting the master NFT into the plurality of segments comprises segmenting an image corresponding to the master NFT into the plurality of segments, each segment representing a portion of the image, and wherein at least one segment of the plurality of segments corresponds to two or more assets of the plurality of assets.

7. A system comprising:
at least one processor programmed or configured to:
mint a master non-fungible token (NFT) on a blockchain network;
segment the master NFT into a plurality of segments, each segment of the plurality of segments corresponding to at least one asset of a plurality of assets on the blockchain network;
issue assets of the plurality of assets to a plurality of users based on the plurality of users conducting eligible transactions;
validate a request from a user of the plurality of users based on determining that the user has possession of a set of assets of the plurality of assets corresponding to the plurality of segments; and
in response to validating the request, transfer the master NFT to the user via the blockchain network.

8. The system of claim 7, wherein the at least one processor is programmed or configured to:
mint a plurality of individual NFTs on the blockchain network, each individual NFT representing a segment of the plurality of segments.

9. The system of claim 8, wherein issuing assets to the plurality of users comprises transferring ownership of individual NFTs to users via smart contracts on the blockchain network.

10. The system of claim 8, wherein issuing assets to the plurality of users comprises transferring the individual NFTs to the users via the blockchain network.

11. The system of claim 7, wherein the master NFT comprises an image asset, and wherein each segment of the plurality of segments corresponds to a different portion of the image asset.

12. The system of claim 7, wherein segmenting the master NFT into the plurality of segments comprises segmenting an image corresponding to the master NFT into the plurality of segments, each segment representing a portion of the image, and wherein at least one segment of the plurality of segments corresponds to two or more assets of the plurality of assets.

13. A computer program product comprising at least one non-transitory computer-readable medium including program instructions that, when executed by at least one processor, cause the at least one processor to:
mint a master non-fungible token (NFT) on a blockchain network;
segment the master NFT into a plurality of segments, each segment of the plurality of segments corresponding to at least one asset of a plurality of assets on the blockchain network;
issue assets of the plurality of assets to a plurality of users based on the plurality of users conducting eligible transactions;
validate a request from a user of the plurality of users based on determining that the user has possession of a set of assets of the plurality of assets corresponding to the plurality of segments; and
in response to validating the request, transfer the master NFT to the user via the blockchain network.

14. The computer program product of claim 13, wherein the program instructions further cause the at least one processor to:
mint a plurality of individual NFTs on the blockchain network, each individual NFT representing a segment of the plurality of segments.

15. The computer program product of claim 14, wherein issuing assets to the plurality of users comprises transferring ownership of individual NFTs to users via smart contracts on the blockchain network.

16. The computer program product of claim 14, wherein issuing assets to the plurality of users comprises transferring the individual NFTs to the users via the blockchain network.

17. The computer program product of claim 13, wherein the master NFT comprises an image asset, and wherein each segment of the plurality of segments corresponds to a different portion of the image asset.

18. The computer program product of claim 13, wherein segmenting the master NFT into the plurality of segments comprises segmenting an image corresponding to the master NFT into the plurality of segments, each segment representing a portion of the image, and wherein at least one segment of the plurality of segments corresponds to two or more assets of the plurality of assets.
